(19) United States
(12) Patent Application Publication
(10) Pub. No.: US 2026/0087396 A1
(43) Pub. Date: Mar. 26, 2026

(54) ZERO-NOISE EXTRAPOLATION OF QUANTUM CIRCUIT SWITCH INSTRUCTIONS

(71) Applicant: International Business Machines Corporation, Armonk, NY (US)

(72) Inventors: Daniel Josef Egger, Zurich (CH); Caroline Tornow, Zurich (CH); Diego Ristè, Watertown, MA (US); Almudena Carrera Vazquez, Thalwil (CH); Stefan Woerner, Zürich (CH); MAIKA TAKITA, Croton on Hudson, NY (US)

(21) Appl. No.: 18/523,211

(22) Filed: Nov. 29, 2023

(51) Int. Cl. G06N 10/70; G06N 10/20; G06N 10/40

(52) U.S. Cl. CPC G06N 10/70; G06N 10/20; G06N 10/40

(57) ABSTRACT

Systems/techniques that facilitate zero-noise extrapolation of quantum circuit switch statements are provided. In various embodiments, a system can comprise a modification component that can insert quantum gates or pulses in delays of the concurrent switch instructions to cause the delays to satisfy assumptions of zero-noise extrapolation, an execution component that can execute the quantum circuit a plurality of times, wherein a different stretch factor is used to stretch delays of the switch instructions for a subset of executions, and an analysis component that can extrapolate one or more measured observables from the plurality of executions to a zero-delay limit. Furthermore, the analysis component can measure noise within the switch instructions that can violate assumptions of zero-noise extrapolation, and therefore determine a dynamical decoupling sequence to employ based on the measured noise.

### BACKGROUND

The subject disclosure relates to quantum circuit error mitigation and, more specifically, to zero-noise extrapolation of quantum circuit switch statements.

### SUMMARY

The following presents a summary to provide a basic understanding of one or more embodiments described herein. This summary is not intended to identify key or critical elements, delineate scope of particular embodiments or scope of claims. Its sole purpose is to present concepts in a simplified form as a prelude to the more detailed description that is presented later. In one or more embodiments described herein, systems, computer-implemented methods, apparatus and/or computer program products that enable zero-noise extrapolation of quantum circuit switch statements.

According to an embodiment, a computer-implemented system is provided. The computer-implemented system can comprise a memory that can store computer executable components. The computer-implemented system can further comprise a processor that can execute the computer executable components stored in the memory, wherein the computer executable components can comprise a modification component that inserts quantum gates or pulses in delays of one or more switch instructions in a quantum circuit to cause the delays to satisfy assumptions of zero-noise extrapolation. The computer executable components can further comprise an execution component that performs a plurality of executions of the quantum circuit and stretches the delays of the one or more switch instructions by a distinct stretch factor for a subset of executions. The computer executable components can even further comprise an analysis component that extrapolates one or more measured observables from the plurality of executions to a zero-delay limit.

According to another embodiment, a computer-implemented method is provided. The computer-implemented method can comprise inserting, by a system operatively coupled to a processor, quantum gates or pulses in delays of one or more switch instructions in the quantum circuit such that the delays satisfy assumptions of zero-noise extrapolation. The computer-implemented method can further comprise performing, by the system, a plurality of executions of the quantum circuit and stretching the delays of the one or more switch instructions by a distinct stretch factor for a subset of executions. The computer-implemented method can even further comprise extrapolating, by the system, one or more measured observables from the plurality of executions to a zero-delay limit.

According to yet another embodiment, a computer program product for facilitating zero-noise extrapolation of quantum circuit switch statements is provided. The computer program product can comprise a computer readable storage medium having program instructions embodied therewith, the program instructions executable by a processor to cause the processor to insert quantum gates or pulses in delays of one or more switch instructions in the quantum circuit such that the delays satisfy assumptions of zero-noise extrapolation, perform a plurality of executions of the quantum circuit and stretching the delays of the one or more switch instructions by a distinct stretch factor for a subset of executions, and extrapolate one or more measured observables from the plurality of executions to a zero-delay limit.

### BRIEF DESCRIPTION OF THE DRAWINGS

FIG. 1 illustrates a block diagram of an example, non-limiting system that can facilitate zero-noise extrapolation of quantum circuit switch statements in accordance with one or more embodiments described herein.

FIG. 2 illustrates a block diagram of an example, non-limiting system that can facilitate zero-noise extrapolation of quantum circuit switch statements in accordance with one or more embodiments described herein.

FIG. 3 illustrates a block diagram of a quantum system that can be employed in connection with the non-limiting systems of FIGS. 1 and 2 in accordance with one or more embodiments described herein.

FIG. 4 illustrates an example, non-limiting representation of four-case switch delays in accordance with one or more embodiments described herein.

FIG. 5 illustrates an example, non-limiting representation of concurrent switch identification of a quantum circuit in accordance with one or more embodiments described herein.

FIG. 6 illustrates a block diagram of an example, non-limiting representation of concurrent switch padding in a quantum circuit in accordance with one or more embodiments described herein.

FIG. 7 illustrates a block diagram of an example, non-limiting representation of dynamic decoupling in a quantum circuit in accordance with one or more embodiments described herein.

FIG. 8 illustrates a block diagram of an example, non-limiting representation of quantum circuit execution with distinct stretch factors in accordance with one or more embodiments described herein.

FIG. 9 illustrates a block diagram of an example, non-limiting representation of zero-noise extrapolation of quantum circuit executions in accordance with one or more embodiments described herein.

FIG. 10 illustrates a block diagram of an example, non-limiting representation of noise identification in a quantum circuit in accordance with one or more embodiments described herein.

FIG. 11 illustrates a flow diagram of an example, non-limiting method facilitating zero-noise extrapolation of quantum circuit switch statements in accordance with one or more embodiments described herein.

FIG. 12 illustrates a flow diagram of an example, non-limiting method facilitating zero-noise extrapolation of quantum circuit switch statements in accordance with one or more embodiments described herein.

FIG. 13 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

A switch statement (e.g., switch instruction) is a code execution model that, in one embodiment, can sequentially iterate over a number of cases. If conditions of a case is satisfied, the code block corresponding to that case can be executed. In another embodiment a switch statement can jump in constant time to the code block of a case corresponding to a value of a classical register. Furthermore, a final measurement is a measurement that is the last instruction executed in a qubit, and a mid-circuit measurement is a measurement in a quantum circuit that is not the final measurement. In various aspects, a dynamic quantum circuit is a quantum circuit in which a mid-circuit measurement classically controls execution of an instruction that occurs within the coherence time of qubits. In dynamic quantum circuits, control electronics decide which blocks of code are to be executed. More specifically, qubits can be measured, and the measurements can be stored in a classical register. Based on the stored measurements in the classical register, particular quantum gates can be applied. In other words, measurements stored in the classical register are used to determine which code block to switch to.

However, current methods of error mitigation in a quantum circuit can fail to account for errors that occur within delays of switch statements in the quantum circuit. More specifically, the process of determining which code block to execute can consume time, during which errors in the quantum system can accumulate. For example, a switch statement can have various types of delays (e.g., base delays, case delays) of various durations. Moreover, delays can be dependent of the number of cases within a switch instruction, further consuming time that can allow for accumulation of errors within the quantum circuit.

Furthermore, insertion of gates between two distant qubits can be desired from a quantum processor with a number of qubits that can have limited connectivity between the qubits. Current methods typically employ swapping qubits throughout the lattice of qubits. Qubit swapping is an operation such that the states of two qubits are exchanged. However, qubit swapping can be costly in errors. For example, qubits are highly susceptible to environmental factors (e.g., electromagnetic radiation, temperature fluctuations, or other forms of noise). Thus, qubit swapping can cause the qubits to be exposed to different environmental conditions, leading to changes in their states and introducing errors. As another example, qubits in a quantum processor are typically coupled, and operations on one qubit can affect neighboring qubits due to crosstalk. During qubit swapping, unintended interactions between qubits may occur, leading to errors. To avoid errors arising from qubits swapping or other methods to create a gate between two distant qubits, a dynamic quantum circuit that employs one or more switch statements can be implemented instead. More specifically, dynamic quantum circuits can enable efficient implementations of quantum algorithms and allow, for example, virtual gates to employ local operations or classical communication, wherein states of neighboring qubits can be measured to determine which operations to executed on the distant qubits. Therefore, the methods described herein can error mitigate switch statements within the dynamic quantum circuit to enable efficient implementations of quantum algorithms and mitigate errors arising from limited connectivity of qubits.

Moreover, utilization of switch statements to execute classically controlled quantum operations can enable efficient execution by minimization of qubit idle time wherein control electronics determine which circuit instruction to execute. Although, the resulting idle time can still comprise a long duration. For example, if on a single quantum processing unit (QPU), the maximum number of measurements that a quantum circuit switch instruction can operate on is 10 measurements, then the number of cases to evaluate can be as large as 2¹⁰ cases which can result in delays comparable to the qubit coherence times. If multiple QPUs are connected, the duration of the switch can increase. Thus, the methods described herein can mitigate errors that can occur during delays of switch statements by performing zero-noise extrapolation.

Accordingly, systems or techniques that can address one or more of these technical problems can be desirable.

Various embodiments described herein can address one or more of these technical problems. One or more embodiments described herein can include systems, computer-implemented methods, apparatus, or computer program products that can facilitate zero-noise extrapolation of quantum circuit switch statements. That is, various disadvantages associated with existing techniques for quantum circuit error mitigation can be ameliorated by zero-noise extrapolation of quantum circuit switch statements.

Zero-noise extrapolation is an error mitigation technique wherein an expectation value is computed at various noise levels and an ideal expectation value is inferred by extrapolating measured observables to a zero-noise limit.

In various embodiments, an identification component can identify concurrent switch instructions within a quantum circuit. Furthermore, the identification component can insert barriers into the quantum circuit to cause concurrent switch instructions to begin simultaneously. In various aspects, a modification component can insert quantum gates or pulses in delays of the concurrent switch instructions to cause the delays to satisfy assumptions of zero-noise extrapolation. Thus, an execution component can execute the quantum circuit a plurality of times, wherein a different stretch factor is used to stretch delays of the switch instructions for a subset of executions. In various embodiments, an analysis component can extrapolate one or more measured observables from the plurality of executions to a zero-delay limit. Moreover, the analysis component can measure noise within the switch instructions that can violate assumptions of zero-noise extrapolation, and therefore determine a dynamical decoupling sequence to employ based on the measured noise. In various aspects, methods described herein can be further implemented in other instructions, such as if-else operations, in a quantum circuit to mitigate errors arising from delays.

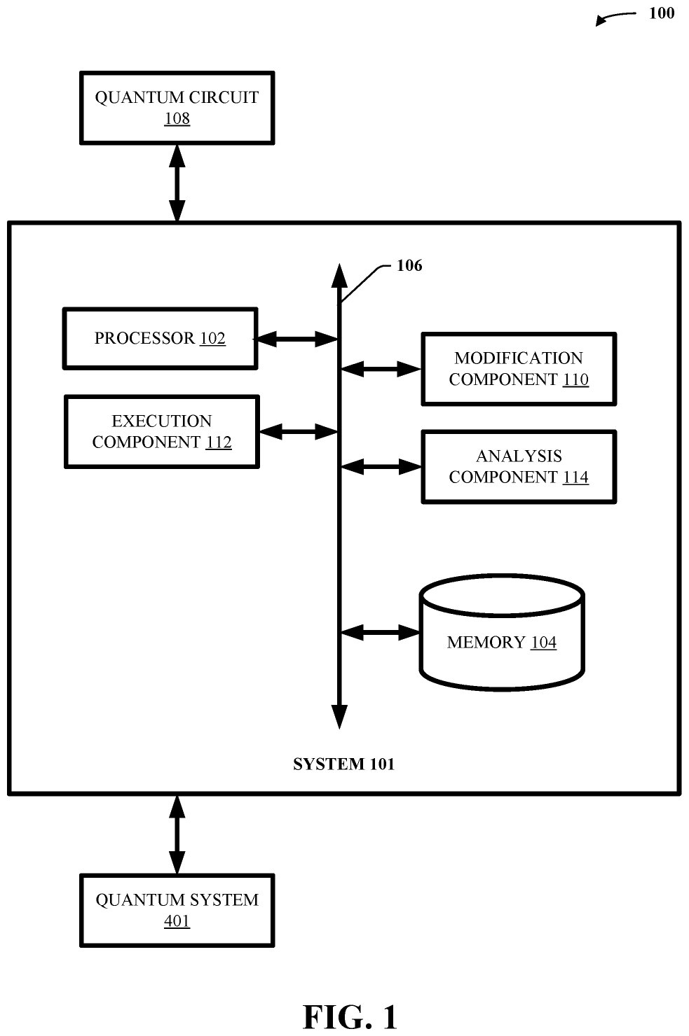

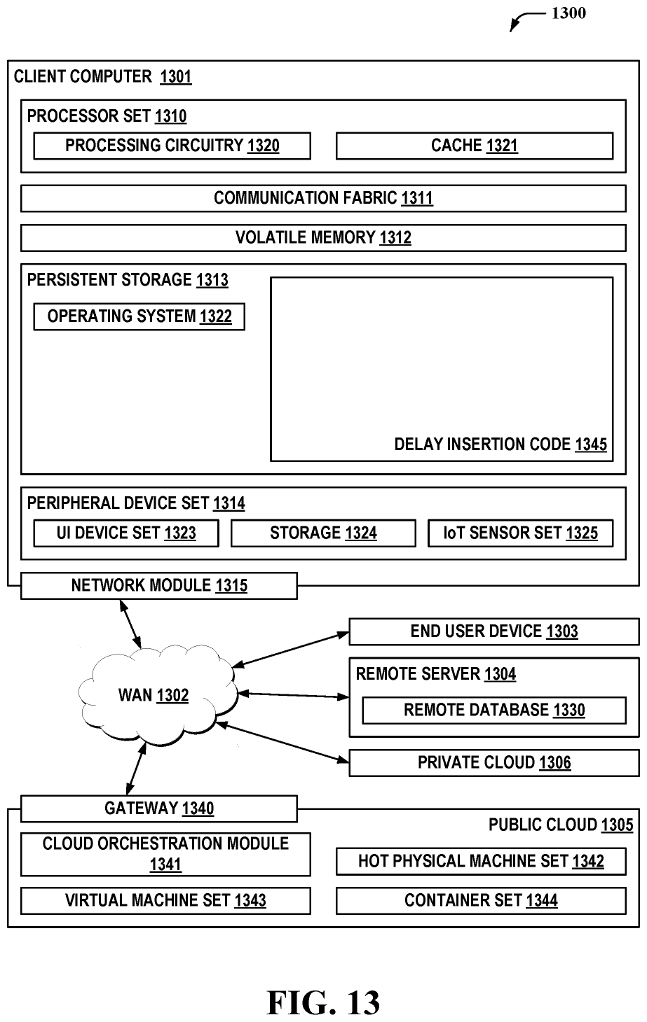

The embodiments depicted in one or more figures described herein are for illustration only, and as such, the architecture of embodiments is not limited to the systems, devices and/or components depicted therein, nor to any particular order, connection and/or coupling of systems, devices and/or components depicted therein. For example, in one or more embodiments, the non-limiting systems described herein, such as non-limiting system 100 as illustrated at FIG. 1, and/or systems thereof, can further comprise, be associated with and/or be coupled to one or more computer and/or computing-based elements described herein with reference to an operating environment, such as the operating environment 1300 illustrated in FIG. 13. For example, system 100 can be associated with, such as accessible via, a computing environment 1300 described below with reference to FIG. 13, such that aspects of processing can be distributed between system 100 and the computing environment 1300. In one or more described embodiments, computer and/or computing-based elements can be used in connection with implementing one or more of the systems, devices, components and/or computer-implemented operations shown and/or described in connection with FIG. 1 and/or with other figures described herein.

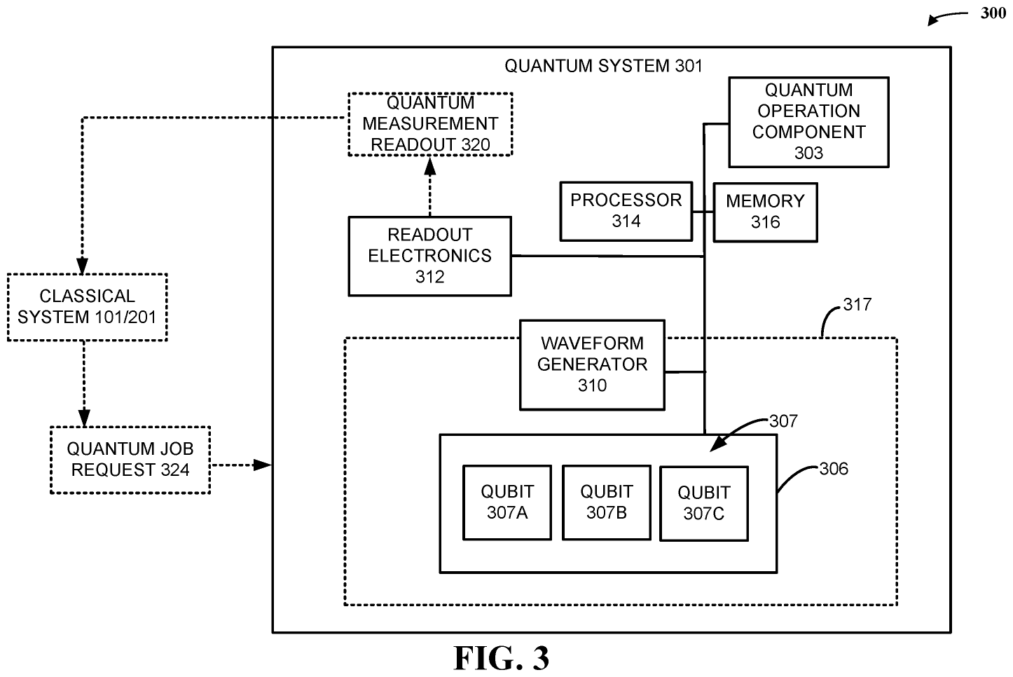

FIG. 1 illustrates a block diagram of an example, non-limiting system 100 that facilitates zero-noise extrapolation of quantum circuit switch statements in accordance with one or more embodiments described herein. That is, the non-limiting system 100 can facilitate the process to train a combination of multiple quantum and classical kernels, in combination with employment of a quantum system 301 (FIG. 3).

The non-limiting system 100 can comprise a system 101 and a quantum system 400, to be described in detail below. System 101 can comprise processor 102, memory 104, system bus 106, modification component 110, execution component 112, and analysis component 114.

The system 100 and/or the components of the system 100 can be employed to use hardware and/or software to solve problems that are highly technical in nature (e.g., quantum circuit error mitigation, quantum operation execution, etc.), that are not abstract and that cannot be performed as a set of mental acts by a human. Further, some of the processes performed may be performed by specialized computers for carrying out defined tasks related to zero-noise extrapolation of quantum circuit switch statements. The system 100 and/or components of the system can be employed to solve new problems that arise through advancements in technology, computer networks, the Internet and the like. The system 100 can provide technical improvements to error mitigate quantum circuit switch statements, algorithmic execution efficiency, and/or quantum algorithm implementation, etc.

Discussion turns briefly to processor 102, memory 104 and bus 106 of system 100. For example, in one or more embodiments, the system 100 can comprise processor 102 (e.g., computer processing unit, microprocessor, classical processor, and/or like processor). In one or more embodiments, a component associated with system 100, as described herein with or without reference to the one or more figures of the one or more embodiments, can comprise one or more computer and/or machine readable, writable and/or executable components and/or instructions that can be executed by processor 102 to enable performance of one or more processes defined by such component(s) and/or instruction(s).

In one or more embodiments, system 100 can comprise a computer-readable memory (e.g., memory 104) that can be operably connected to the processor 102. Memory 104 can store computer-executable instructions that, upon execution by processor 102, can cause processor 102 and/or one or more other components of system 100 (e.g., modification component 110, execution component 112, and/or analysis component 114) to perform one or more actions. In one or more embodiments, memory 104 can store computer-executable components (e.g., modification component 110, execution component 112, and/or analysis component 114).

System 100 and/or a component thereof as described herein, can be communicatively, electrically, operatively, optically and/or otherwise coupled to one another via bus 106. Bus 106 can comprise one or more of a memory bus, memory controller, peripheral bus, external bus, local bus, and/or another type of bus that can employ one or more bus architectures. One or more of these examples of bus 106 can be employed. In one or more embodiments, system 100 can be coupled (e.g., communicatively, electrically, operatively, optically and/or like function) to one or more external systems (e.g., a non-illustrated electrical output production system, one or more output targets, an output target controller and/or the like), sources and/or devices (e.g., classical computing devices, communication devices and/or like devices), such as via a network. In one or more embodiments, one or more of the components of system 100 can reside in the cloud, and/or can reside locally in a local computing environment (e.g., at a specified location(s)).

In addition to the processor 102 and/or memory 104 described above, system 100 can comprise one or more computer and/or machine readable, writable and/or executable components and/or instructions that, when executed by processor 102, can enable performance of one or more operations defined by such component(s) and/or instruction(s). For example, the modification component 110 can insert quantum gates within a delay of a switch instruction to cause the delay to satisfy assumptions of zero-noise extrapolation. Accordingly, the execution component 112 can perform a plurality of executions of a quantum circuit containing the switch instructions and stretch the delays of the one or more switch instructions by a distinct stretch factor for a subset of executions. Thus, the analysis component 114 can extrapolate one or more measured observables from the plurality of executions to a zero-delay limit. Additional aspects of the one or more embodiments discussed herein are explained in greater detail with reference to subsequent figures. System 100 can be associated with, such as accessible via, a computing environment 1400 described below with reference to FIG. 14. For example, system 100 can be associated with a computing environment 1400 such that aspects of processing can be distributed between system 100 and the computing environment 1400.

In various aspects, the modification component 110 can optionally enforce the concurrent switch instructions to comprise equivalent durations. The modification component 110 can enforce the constraint of duration equivalency by padding delays of each concurrent switch instruction such that they comprise the same average or total delay duration.

In various embodiments, as described herein, the modification component 110 can insert quantum gates or pulses in delays of one or more switch instructions in a quantum circuit 108 to cause the delays satisfy assumptions of zero-noise extrapolation. More specifically, the modification component 110 can insert quantum operations on idling qubits, such as dynamical decoupling sequences or Pauli twirling to shape occurring noise into a format that enables application of zero-noise extrapolation. Insertion of quantum operations to reshape noise can mitigate or cancel spurious couplings that may occur between qubits and therefore prevent errors from occurring.

In various embodiments, as described herein, the execution component 112 can perform a plurality of executions, on the quantum system 401, of the quantum circuit 108 and stretch the delays of the one or more switch instructions by a distinct stretch factor for a subset of executions.

In various embodiments, as described herein, the analysis component 114 can extrapolate one or more measured observables from the plurality of executions to a zero-delay limit.

As a result of the modification component 110 inserting quantum gates or pulses in delays of the one or more switch instructions to cause the delays to satisfy assumptions of zero-noise extrapolation, the execution component 112 can execute the quantum circuit a plurality of times wherein the delays are stretched by a stretch factor. The execution component 112 can employ a different value of the stretch factor for each execution or subset of executions. Therefore, stretching the delay can cause more errors to occur as the time consumed in the delay increases. In other words, stretching the delay by distinct factors allows for computation of expectation values for various levels of noise. Thus, the analysis component 114 can extrapolate measured expectation values of the one or more observables to a zero-delay limit (e.g., zero-noise limit) to enable mitigation of the errors in delays in the switch instructions.

In various aspects, the analysis component 114 can optionally perform noise identification methods to identify terms during a delay that can violate assumptions of zero-noise extrapolation. Therefore, the analysis component 114 can determine, based on the measured terms, quantum operations for the modification components 110 to insert.

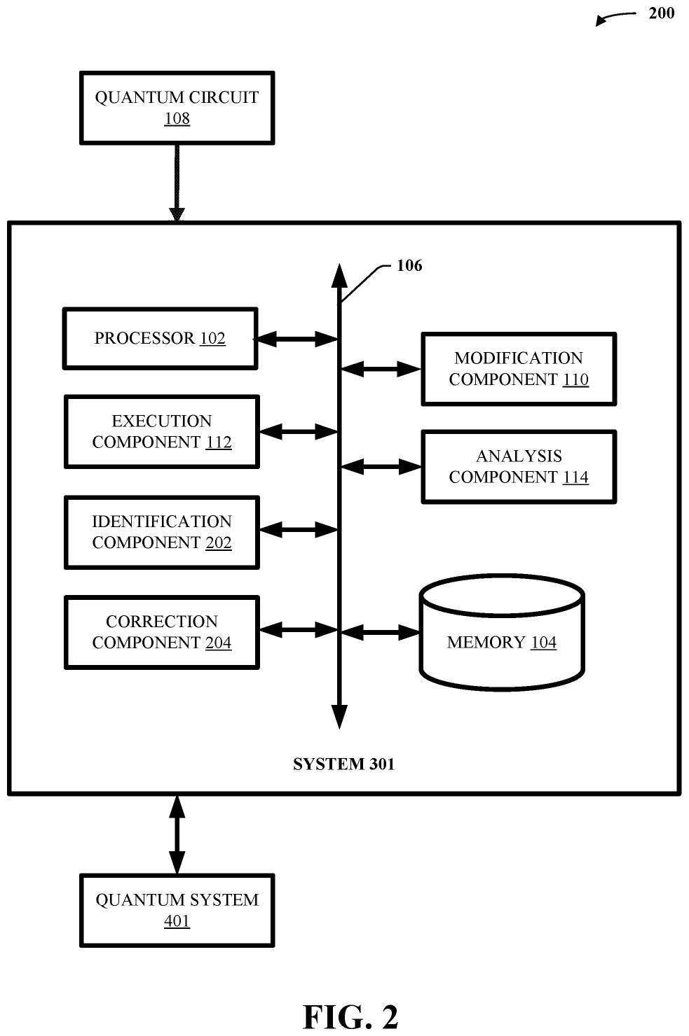

FIG. 2 illustrates a block diagram of an example, non-limiting system 200 that can facilitate zero-noise extrapolation of quantum circuit switch statements in accordance with one or more embodiments described herein. As shown, the system 200 can comprise the same components as the system 100 and can, in some cases, further comprise an identification component 202 and a correction component 204.

In various embodiments, the identification component 202 can identify switch instructions that are concurrent (e.g., can be executed simultaneously). Furthermore, the identification component 202 can place two or more switch instructions in the quantum circuit 108 such that the two or more switch instructions are parallel. More specifically, if for example two switch instructions are taking place on independent registers and affect independent qubits, then the identification component 202 can place the switch instructions so the two switch instructions can be executed in parallel. In various cases, the identification component 202 can place barriers in quantum circuit 108 to cause the switch instructions to begin simultaneously in the quantum circuit 108 upon execution. In various cases, the identification component 202 can also schedule the quantum circuit 108 to cause the switch instructions to begin simultaneously.

In various embodiments, the correction component 204 can error-mitigate qubits that are not involved in the concurrent switch instructions. The correction component 204 can employ any suitable methods to mitigate errors or noise within the quantum circuit 108. Therefore, error mitigation can occur for qubits outside of the concurrent switch statements as well as for qubits within the concurrent switch statements.

Turning to FIG. 3, one or more embodiments described herein can include one or more devices, systems and/or apparatuses that can provide a process to facilitate zero-noise extrapolation of quantum circuit switch statements. Accordingly, at FIG. 3, illustrated is a block diagram of an example, non-limiting system 300 that can at least partially facilitate such a process. While referring here to one or more processes, facilitations and/or uses of the non-limiting system 300, description provided herein, both above and below, also can be relevant to one or more other non-limiting systems described herein, such as the non-limiting systems 100 and/or 200.

As illustrated at FIG. 3, the non-limiting system 300 can comprise a quantum system 301 that can be employed with or separate from the classical system 101.

Generally, the quantum system 301 (e.g., quantum computer system, superconducting quantum computer system and/or the like) can employ quantum algorithms and/or quantum circuitry, including computing components and/or devices, to perform quantum operations and/or functions on input data to produce results that can be output to an entity. The quantum circuitry can comprise quantum bits (qubits), such as multi-bit qubits, physical circuit level components, high level components and/or functions. The quantum circuitry can comprise physical pulses that can be structured (e.g., arranged and/or designed) to perform desired quantum functions and/or computations on data (e.g., input data and/or intermediate data derived from input data) to produce one or more quantum results as an output. The quantum results, e.g., quantum measurement readout 320, can be responsive to the quantum job request 324 and associated input data and can be based at least in part on the input data, quantum functions and/or quantum computations.

In one or more embodiments, the quantum system 301 can comprise components, such as a quantum operation component 303, a quantum processor 306, pulse component 310 (e.g., a waveform generator) and/or a readout electronics 312 (e.g., readout component). In one or more other embodiments, the readout electronics 312 can be comprised at least partially by the classical system 101 and/or be external to the quantum system 301. The quantum processor 306 can comprise one or more, such as plural, qubits 307. Individual qubits 307A, 307B and 307C, for example, can be fixed frequency and/or single junction qubits, such as transmon qubits.

In one or more embodiments, a memory 316 and/or processor 314 can be associated with the quantum operation component 303, where suitable. The processor 314 can be any suitable processor. The processor 314 can generate one or more instructions for controlling the one or more processes of the quantum operation component 303.

The quantum operation component 303 can obtain (e.g., download, receive, search for and/or the like) a quantum job request 324 requesting execution of one or more quantum programs and/or a physical qubit layout. The quantum job request 324 can be provided in any suitable format, such as a text format, binary format and/or another suitable format. In one or more embodiments, the quantum job request 324 can be obtained by a component other than of the quantum system 301, such as a by a component of the classical system 101.

The quantum operation component 303 can determine mapping of one or more quantum logic circuits for executing a quantum program. In one or more embodiments, the quantum operation component 303 and/or quantum processor 306 can direct the waveform generator 310 to generate one or more pulses, tones, waveforms and/or the like to affect one or more qubits 307, such as in response to a quantum job request 324.

The waveform generator 310 can generally cause the quantum processor 306 to perform one or more quantum processes, calculations and/or measurements by creating a suitable electromagnetic signal. For example, the waveform generator 310 can operate one or more qubit effectors, such as qubit oscillators, harmonic oscillators, pulse generators and/or the like to cause one or more pulses to stimulate and/or manipulate the state(s) of the one or more qubits 307 comprised by the quantum system 301.

The quantum processor 306 and a portion or all of the waveform generator 310 can be contained in a cryogenic environment, such as generated by a cryogenic environment 317, such as effected by a dilution refrigerator. Indeed, a signal can be generated by the waveform generator 310 to affect one or more of the plurality of qubits 307. Where the plurality of qubits 307 are superconducting qubits, cryogenic temperatures, such as about 4K or lower, can be employed for function of these physical qubits. Accordingly, one or more elements of the readout electronics 312 also can be constructed to perform at such cryogenic temperatures.

Moreover, switch instructions or other control-flow instructions (e.g., if-else instructions) can act on multiple quantum processors More specifically, measurements can result from one quantum processor and conditional operations can be applied on a second quantum processor that enables the classical control system to create connections between distinct quantum processors.

The readout electronics 312, or at least a portion thereof, can be contained in the cryogenic environment 317, such as for reading a state, frequency and/or other characteristic of qubit, excited, decaying or otherwise.

It is noted that the aforementioned description(s) refer(s) to the operation of a single set of instructions run on a single qubit. However, scaling can be achieved. For example, instructions can be calculated, transmitted, employed and/or otherwise used relative to one or more qubits (e.g., non-neighbor qubits) in parallel with one another, one or more quantum circuits in parallel with one another, and/or one or more qubit mappings in parallel with one another.

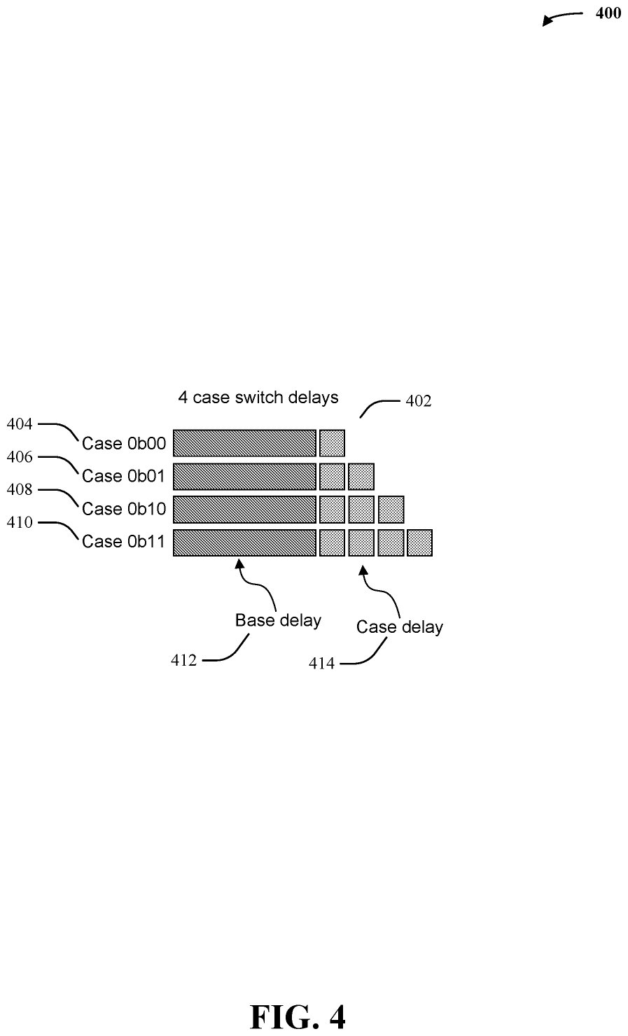

FIG. 4 illustrates an example, non-limiting representation of four-case switch delays in accordance with one or more embodiments described herein.

FIG. 4 provides an example implementation of a switch statement 402 and delays.

However, other implementations of the switch statement 402 and delays can be used in the methods described herein. In various embodiments, the switch statement 402 can be conditioned on two measurements and contain two classical bits. Therefore, the switch statement 402 can comprise four cases (e.g., case 404, case 406, case 408, and case 410). In various aspects, the switch statement 402 can contain delays. For example, in implementation of switch statement 402, it can contain a base delay 412 and case delay 414. However, depending on implementation, the switch statement 402 can contain other configurations of delays. For example, the switch statement 402 can contain a base delay but not contain a case delay. The base delay 412 is equivalent in duration for each case of the switch statement 402. The case delay 414 is a duration of time it takes to determine if a code block of a case should be executed or not executed. More specifically, as the switch statement 402 sequentially iterates through the cases, a delay is incurred for each case. Therefore, duration of the switch depends on the state of the classical register (e.g., measurement of qubits).

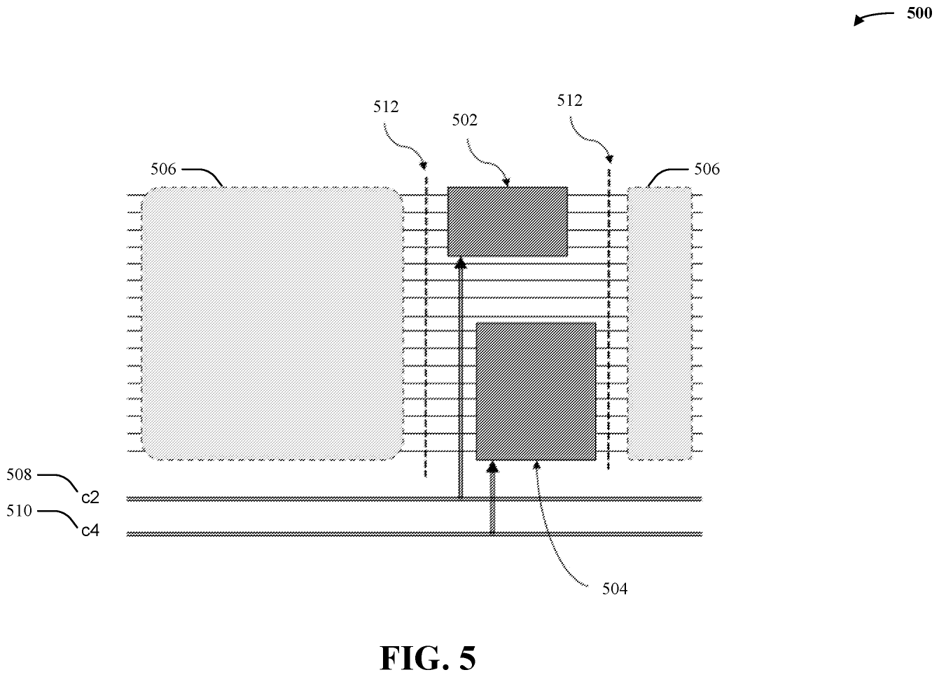

FIG. 5 illustrates an example, non-limiting representation of concurrent switch identification of a quantum circuit in accordance with one or more embodiments described herein.

In various embodiments, the identification component 202 can identify concurrent switches in quantum circuit 108. For example, quantum circuit 108 can contain a switch instruction 502 and a switch instruction 504. Furthermore, switch instruction 502 and switch instruction 504 are concurrent (e.g., can be executed simultaneously). Depicted at 506, there can be additional quantum gates or measurements in the quantum circuit 108. Moreover, such measurements can, for example, be stored in classical register 508 (e.g., c2) and classical register 510 (e.g., c4).

Although two concurrent switch instructions (e.g., switch instruction 502, switch instruction 504) are depicted in FIG. 5, the quantum circuit 108 can contain more than two concurrent switch instructions, to which the methods described herein can be applied.

In various aspects, switch instruction 502 and switch instruction 504 can be conditioned on different classical registers (e.g., c2 and c4) and act on different qubits. In some cases, the switches can be independent of one another. Therefore, if switch instruction 502 and switch instruction 504 are executed consecutively (e.g., execute one switch after the other switch), costs can be incurred from delays of switch instruction 502 and from delays of switch instruction 504. Thus, to mitigate costs from both delays, the identification component 202 can place switch statements in parallel so costs are only incurred from delays once. In other words, if switch instructions are executed consecutively, there will exist two separate durations of time in the delays during execution from which errors can arise. Conversely, if switch instructions are executed in parallel, there will exist only one duration of time in the delays during execution from which errors can arise.

In various embodiments, the identification component 202 can enforce parallelism of switch instructions by inserting barriers into quantum circuit 108 or by scheduling (e.g., determining a sequence and timing for execution of quantum gates or operations in a quantum circuit) of the quantum circuit 108. For example, the identification component 202 can insert barriers 512 to cause switch instruction 502 and switch instruction 504 to align in time, such that they start at the same time during execution. The identification component 202 can employ a transpiler to perform insertion or barriers or scheduling.

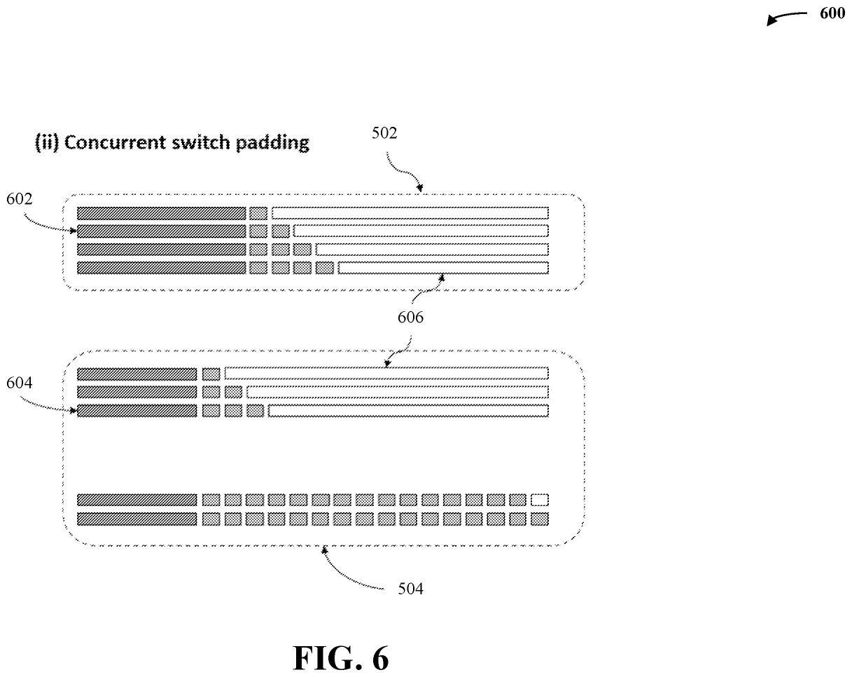

FIG. 6 illustrates a block diagram of an example, non-limiting representation of concurrent switch padding in a quantum circuit in accordance with one or more embodiments described herein.

In various embodiments, the modification component 110 can insert delays into switch instructions to cause the switch instructions to comprise the same duration. More specifically, switch instructions can contain different durations of delays. For example, base delay 602 of switch instruction 502 can be a different duration than base delay 604 of switch instruction 604 (e.g., switch instruction 502 may take place on a single QPU while switch instruction 504 may have classical and quantum bits that span multiple QPUs which can result in a longer base delay 602 than base delay 604). Furthermore, total delay duration can be dependent on the number of cases a switch instruction contains. Thus, if switch instructions contain different numbers of cases or base delays of different durations, the modification component 110 can insert delays (e.g., padding) into each switch instruction to cause the total duration of delays to be equivalent across the switch instructions. For example, the modification component 110 can insert delays 606 into switch instruction 502 and switch instruction 504 so both switch instructions contain the same total duration. In various cases, the modification component 110 can insert delays into switch instructions that do not contain case delays as well. The modification component 110 can employ the transpiler to insert delays into the concurrent switch instructions. Moreover, concurrent switch padding (e.g., delay insertion) can enable consistent treatment of errors. For example, sub-circuits in a multi-QPU quantum system are equally impacted by errors. In various aspects, concurrent switch padding can further enable insertion of quantum operations, such as a dynamical decoupling sequence, and extrapolation to the zero-noise limit by making concurrent switch instructions homogeneous.

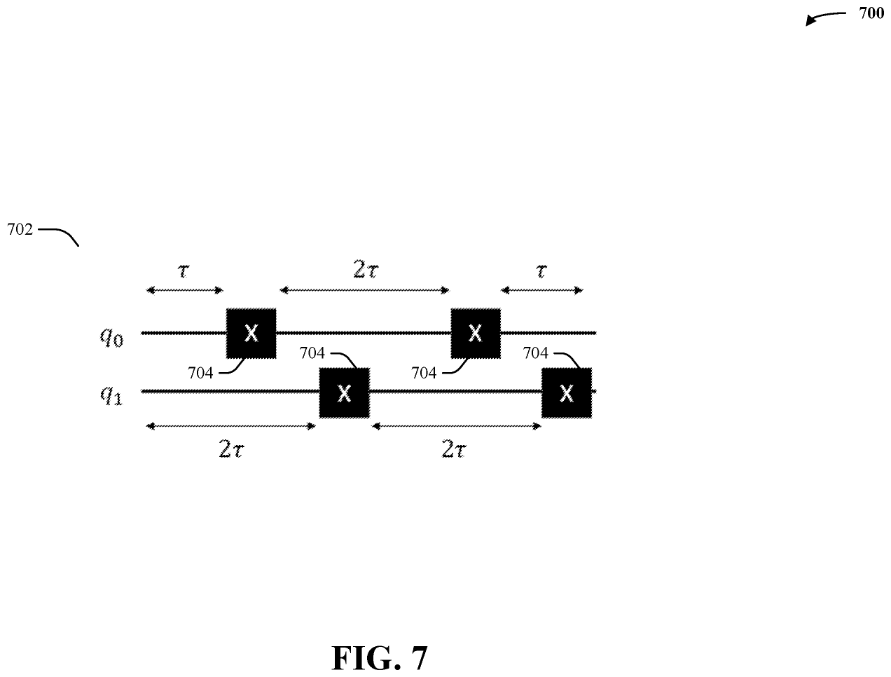

FIG. 7 illustrates a block diagram of an example, non-limiting representation of dynamical decoupling in a quantum circuit in accordance with one or more embodiments described herein.

Zero-noise extrapolation is applicable to time-evolutions of the form

$$\frac{\partial }{\partial t} ρ ( t ) = - i [ K ( t ) , ρ ( t ) ] + λℒ [ ρ ( t ) ] ,$$

where ρ is a density matrix, K(t) is the effect of the quantum circuit 108, [symbol] is a noise generator, and λ is the strength of the noise. In various aspects, zero-noise extrapolation can require assumptions to be satisfied to extrapolate to the zero-noise limit. More specifically, generation of noise strength should be constant, even if time is rescaled. Therefore, the noise strength λ must be constant and [symbol] must be invariant under time rescaling and independent of the parameters in K(t).

During a delay, qubits can suffer from energy-relaxation and phase errors (e.g., T₁ and T₂ related errors, respectively) which satisfy the assumptions of zero-noise extrapolation. However, there may be other noise generators or Hamiltonian terms such as but not limited to IZ, ZI, and ZZ errors, which do not satisfy the assumptions of zero-noise extrapolation. Such errors can lead to an oscillating behavior and render extrapolation to the zero-noise limit unachievable.

For example, if there is an undesired Z-coupling between two qubits of quantum system 401 during a delay, and if delay duration is increased, oscillations can form and violate zero-noise extrapolation assumptions. To mitigate noise generation or Hamiltonian terms, the analysis component 114 can measure noise that can violate the assumptions of zero-noise extrapolation during a delay and determine quantum gates or pulses, such as a dynamical decoupling sequence or Pauli twirling, to insert based on the measured noise. More specifically, the modification component 110 can reshape noise to cancel undesired terms on cross-resonance (e.g., interaction between qubits in a quantum system) based hardware. For example, in quantum circuit 702, two qubits are idling for a period of 4τ. Therefore, the analysis component 114 can determine a staggered dynamical decoupling sequence to cancel the Hamiltonian errors. Thus, the modification component 110 can employ the determined staggered dynamical decoupling sequence by inserting X gates 704 such that Hamiltonian errors IZ, ZI, and ZZ are cancelled to enable zero-noise extrapolation.

In various aspects, dynamical decoupling can comprise implementing periodic sequences of quantum operation or pulses to average undesired couplings to zero. That is, the states of qubits are rapidly or periodically changed in a way that causes the qubits to become insensitive to external disturbances. In various embodiments, Pauli twirling can comprise converting arbitrary noise channels into Pauli error channels. Thus, quantum error correction circuits can be efficiently simulated for various error models. In various aspects, the analysis component 114 can employ either method, or any other suitable method to reshape noise in the switch instructions to allow zero-noise extrapolation.

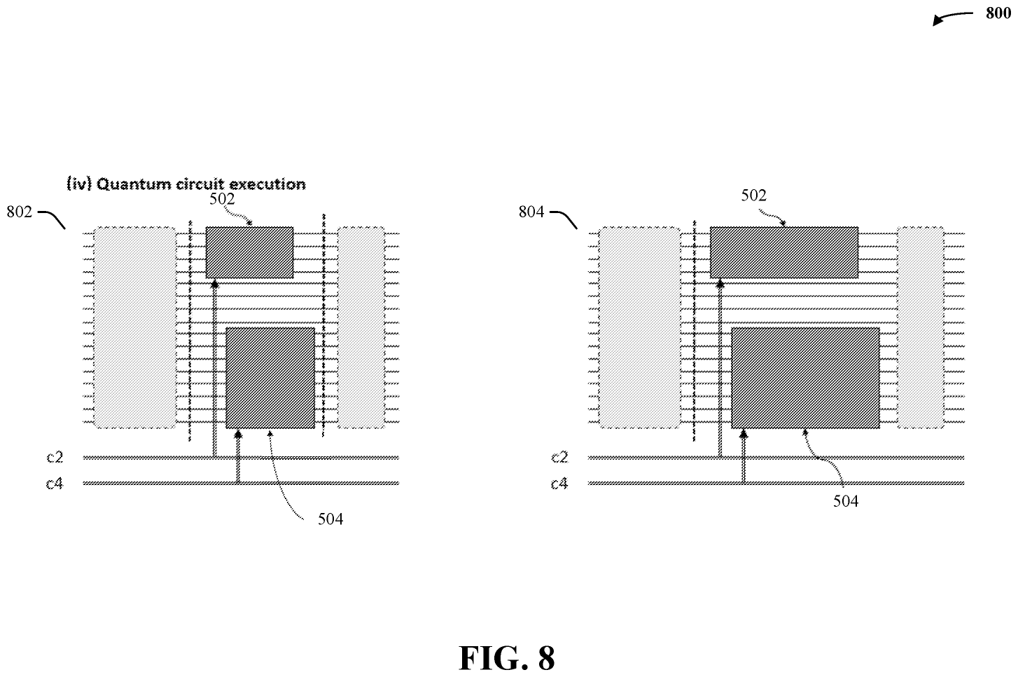

FIG. 8 illustrates a block diagram of an example, non-limiting representation of quantum circuit execution with distinct stretch factors in accordance with one or more embodiments described herein.

FIG. 8 depicts an example quantum circuit 108 containing two switch instructions (e.g., switch instruction 502, switch instruction 504) to be executed two times with a distinct stretch factor c. In various aspects, the execution component 112 can execute the quantum circuit 108 a multitude of times, wherein delays of switch instructions in the quantum circuit 108 are stretched by a different stretch factor c for a subset of executions. In various aspects, a different stretch factor can be used for each execution of quantum circuit 108. Furthermore, stretch factor c≥1 for each execution.

It is assumed in this example that assumptions of zero-noise extrapolation are satisfied, enforced by analysis component 114 through methods previously described. As an example, depicted in 802 and 804, quantum circuit 108 is stretched by two different stretch factors. As shown, the stretch factor used in 804 is larger than the stretch factor used in 802. Therefore, more noise may occur in execution of 804, enabling measurements to be taken of different noise levels. Thus, the execution component 112 can extrapolate the expected values of observables from the executions to the zero-noise limit.

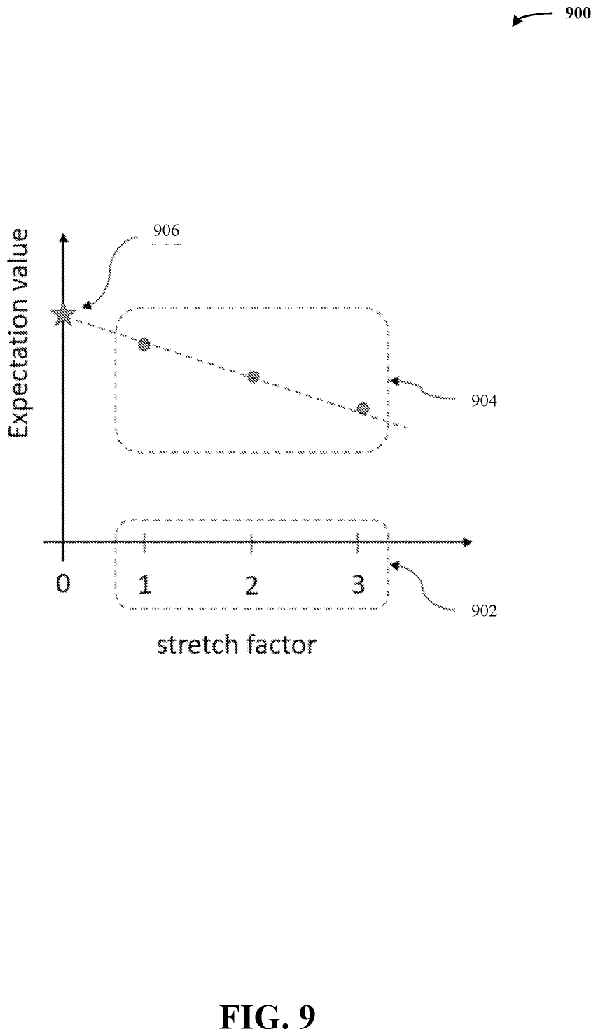

FIG. 9 illustrates a block diagram of an example, non-limiting representation of zero-noise extrapolation of quantum circuit executions in accordance with one or more embodiments described herein.

Plot 900 depicts an example of extrapolation of expected values of one or more observables resulting from a plurality of executions with different stretch factors. The x-axis of plot 900 represents stretch factors 902 and the y-axis of plot 900 represents the expectation values 904 of the one or more observables. In various embodiments, the analysis component 114 can extrapolate the expectation values 904 to the zero-delay limit 906. Expectation values of the one or more observables can be impacted by noise, and thus can be suboptimal. Therefore, zero-noise extrapolation of the expected values can recover a noiseless expectation value that exhibits improved accuracy.

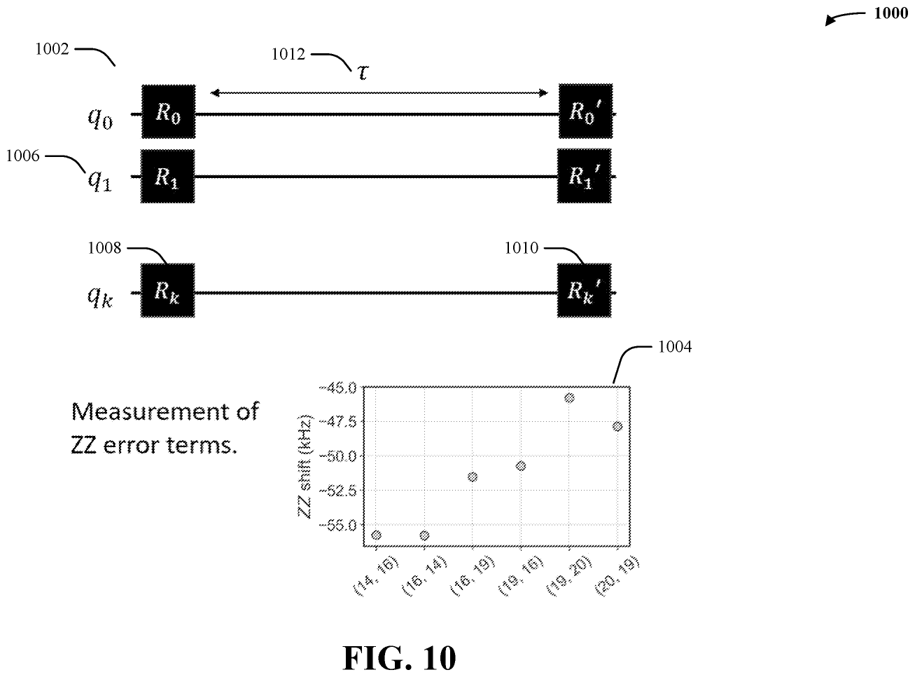

FIG. 10 illustrates a block diagram of an example, non-limiting representation of noise identification in a quantum circuit in accordance with one or more embodiments described herein.

In various embodiments, the analysis component 114 can measure noise that causes violation of the assumptions of zero-noise extrapolation during a delay. In other words, the analysis component 114 can perform noise identification in quantum circuit 108 to learn the impact of unwanted terms during a delay. The analysis component 114 can utilize various methods or experiments for noise identification, such as Ramsey experiments to measure Z terms. In various instances, the analysis component 114 can also perform Hamiltonian tomography to measure strengths of different terms in the Hamiltonian. As another example, the analysis component 114 can use noise learning methods to learn the generators of noise. Furthermore, the analysis component 114 can learn noise through probabilistic error cancellation. In various aspects, probabilistic error cancellation comprises learning noise of layers of gates within a quantum circuit and determining the strength of generators of noise. Probabilistic error cancellation can be employed during delays of switch instructions as well. Thus, the analysis component 114 can determine types of errors that are present in delays of switch instructions in the quantum circuit 108. No matter the method employed, the analysis component 114 can measure terms of noise during a delay and enable determination of a dynamical decoupling sequence, Pauli twirling, or insertion of quantum operations that can cancel (e.g., reshape) the undesired terms or noise.

For example, the analysis component 114 performs Hamiltonian tomography on quantum circuit 1002 to measure noise of error terms, wherein the measurements are depicted in plot 1004. Plot 1104 depicts measurements of ZZ error terms on quantum circuit 1002. More specifically, the analysis component 114 performs Hamiltonian tomography on a set of qubits 1106 by preparing the set of qubits in different states with pre-rotations 1008, denoted by Rᵢ, and measuring in different bases by choosing appropriate post-rotations 1010, denoted by

$${R}_{i}^{′} .$$

The experiment is repeated for different delays 1012, denoted by τ, to evaluate characteristics and strength of error terms occurring in the delay. The error terms can be expressed as a tensor product of Pauli operators. For example, cross-resonance based hardware typically has errors of form ZI, IZ, or ZZ between two qubits. Furthermore, based on the measured error terms, the analysis component 114 can determine a dynamical decoupling sequence that cancels largest error terms by echoing them away.

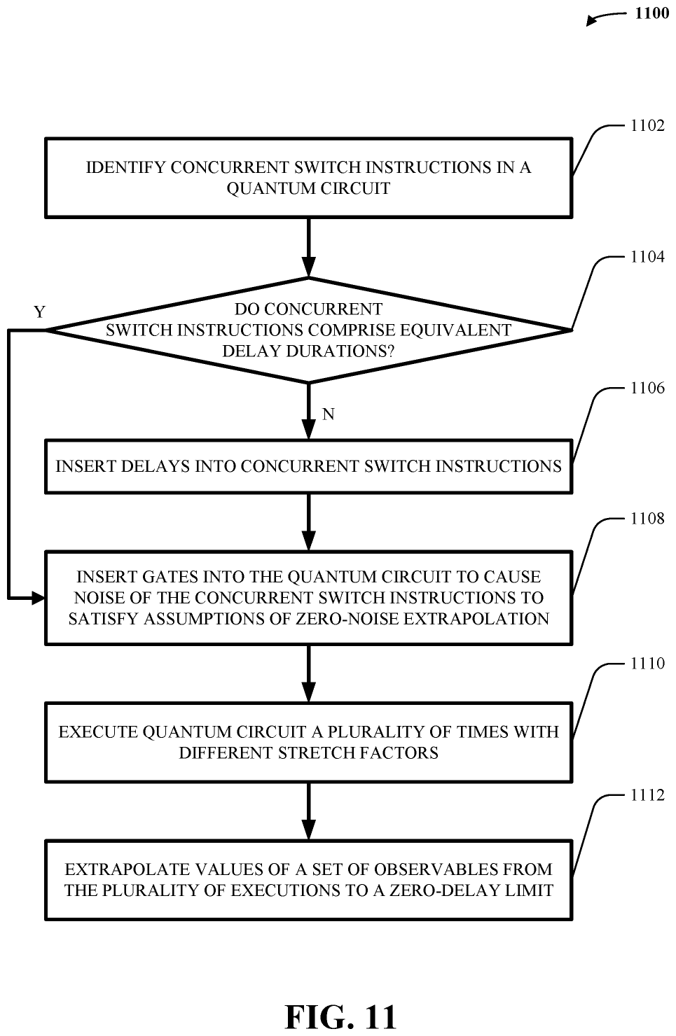

FIG. 11 illustrates a flow diagram of an example, non-limiting method 1100 of facilitating zero-noise extrapolation of quantum circuit switch statements in accordance with one or more embodiments described herein.

At 1102, the non-limiting method 1100 can comprise identifying (e.g., by the identification component 202), by the system, concurrent switch instructions in a quantum circuit.

At 1104, the non-limiting method 1100 can determine if the concurrent switch instructions comprise equivalent delay durations. If yes (e.g., the concurrent switch instructions comprise equivalent delay durations), the non-limiting method 1100 can proceed to 1108. If no (e.g., the concurrent switch instructions do not comprise equivalent total delay durations), the non-limiting method 1100 can proceed to 1106.

At 1106, the non-limiting method 1100 can comprise inserting (e.g., by the modification component 110), by the system, delays into concurrent switch instructions.

At 1108, the non-limiting method 1100 can comprise inserting (e.g., by the modification component 110), by the system, gates into the quantum circuit to cause noise of the concurrent switch instructions to satisfy assumptions of zero-noise extrapolation.

At 1110, the non-limiting method 1100 can comprise executing (e.g., by the execution component 112), by the system, the quantum circuit a plurality of times with different stretch factors.

At 1112, the non-limiting method 1100 can comprise extrapolating (e.g., by the analysis component 114), by the system, values of a set of observables from the plurality of executions to a zero-delay limit.

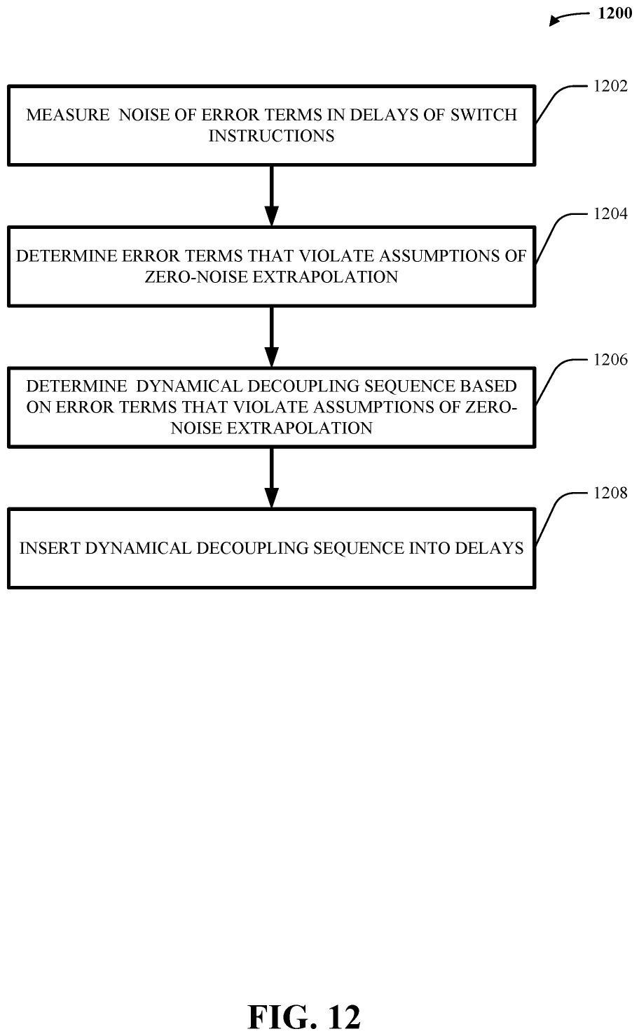

FIG. 12 illustrates a flow diagram of an example, non-limiting method 1200 of facilitating zero-noise extrapolation of quantum circuit switch statements in accordance with one or more embodiments described herein.

At 1202, the non-limiting method 1200 can comprise measuring (e.g., by the analysis component 114), by the system, noise of error terms in delays of switch instructions.

At 1204, the non-limiting method 1200 can comprise determining (e.g., by the analysis component 114), by the system, error terms that violate assumptions of zero-noise extrapolation.

At 1206, the non-limiting method 1200 can comprise determining (e.g., by the analysis component 114), by the system, dynamical decoupling sequence based on error terms that violate assumptions of zero-noise extrapolation.

At 1208, the non-limiting method 1200 can comprise inserting (e.g., by the modification component 110), by the system, dynamical decoupling sequence into delays.

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. Additionally, the computer-implemented methodologies described hereinafter and throughout this specification are capable of being stored on an article of manufacture to enable transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

One or more embodiments described herein can employ hardware and/or software to solve problems that are highly technical, that are not abstract, and that cannot be performed as a set of mental acts by a human. For example, a human, or even thousands of humans, cannot efficiently, accurately and/or effectively perform zero-noise extrapolation of quantum circuit switch statements as the one or more embodiments described herein can enable this process. And, neither can the human mind nor a human with pen and paper perform error mitigation of quantum circuit switch statements, as conducted by one or more embodiments described herein.

FIG. 13 illustrates a block diagram of an example, non-limiting, operating environment in which one or more embodiments described herein can be facilitated. FIG. 10 and the following discussion are intended to provide a general description of a suitable operating environment 1000 in which one or more embodiments described herein at FIGS. 1-9 can be implemented.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1000 contains an example of an environment for the execution of at least some of the computer code involved in performing the inventive methods, such as action profile generation code 1345. In addition to block 1345, computing environment 1000 includes, for example, computer 1301, wide area network (WAN) 1002, end user device (EUD) 1303, remote server 1304, public cloud 1305, and private cloud 1306. In this embodiment, computer 1301 includes processor set 1310 (including processing circuitry 1320 and cache 1321), communication fabric 1311, volatile memory 1312, persistent storage 1313 (including operating system 1322 and block 1345, as identified above), peripheral device set 1314 (including user interface (UI), device set 1323, storage 1324, and Internet of Things (IoT) sensor set 1325), and network module 1315. Remote server 1304 includes remote database 1330. Public cloud 1305 includes gateway 1340, cloud orchestration module 1341, host physical machine set 1342, virtual machine set 1343, and container set 1344.

COMPUTER 1301 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1330. As is well understood in the art of computer technology, and depending upon the technology, performance of a computer-implemented method may be distributed among multiple computers and/or between multiple locations. On the other hand, in this presentation of computing environment 1000, detailed discussion is focused on a single computer, specifically computer 1301, to keep the presentation as simple as possible. Computer 1301 may be located in a cloud, even though it is not shown in a cloud in FIG. 12. On the other hand, computer 1301 is not required to be in a cloud except to any extent as may be affirmatively indicated.

PROCESSOR SET 1310 includes one, or more, computer processors of any type now known or to be developed in the future. Processing circuitry 1320 may be distributed over multiple packages, for example, multiple, coordinated integrated circuit chips. Processing circuitry 1320 may implement multiple processor threads and/or multiple processor cores. Cache 1321 is memory that is located in the processor chip package(s) and is typically used for data or code that should be available for rapid access by the threads or cores running on processor set 1310. Cache memories are typically organized into multiple levels depending upon relative proximity to the processing circuitry. Alternatively, some, or all, of the cache for the processor set may be located “off chip.” In some computing environments, processor set 1310 may be designed for working with qubits and performing quantum computing.

Computer readable program instructions are typically loaded onto computer 1301 to cause a series of operational steps to be performed by processor set 1310 of computer 1301 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1321 and the other storage media discussed below. The program instructions, and associated data, are accessed by processor set 1310 to control and direct performance of the inventive methods. In computing environment 1000, at least some of the instructions for performing the inventive methods may be stored in block 1345 in persistent storage 1313.

COMMUNICATION FABRIC 1311 is the signal conduction paths that allow the various components of computer 1301 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1312 is any type of volatile memory now known or to be developed in the future. Examples include dynamic type random access memory (RAM) or static type RAM. Typically, the volatile memory is characterized by random access, but this is not required unless affirmatively indicated. In computer 1301, the volatile memory 1312 is located in a single package and is internal to computer 1301, but, alternatively or additionally, the volatile memory may be distributed over multiple packages and/or located externally with respect to computer 1301.

PERSISTENT STORAGE 1313 is any form of non-volatile storage for computers that is now known or to be developed in the future. The non-volatility of this storage means that the stored data is maintained regardless of whether power is being supplied to computer 1301 and/or directly to persistent storage 1313. Persistent storage 1313 may be a read only memory (ROM), but typically at least a portion of the persistent storage allows writing of data, deletion of data and re-writing of data. Some familiar forms of persistent storage include magnetic disks and solid state storage devices. Operating system 1322 may take several forms, such as various known proprietary operating systems or open source Portable Operating System Interface type operating systems that employ a kernel. The code included in block 1345 typically includes at least some of the computer code involved in performing the inventive methods.

PERIPHERAL DEVICE SET 1314 includes the set of peripheral devices of computer 1301. Data communication connections between the peripheral devices and the other components of computer 1301 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1323 may include components such as a display screen, speaker, microphone, wearable devices (such as goggles and smart watches), keyboard, mouse, printer, touchpad, game controllers, and haptic devices. Storage 1324 is external storage, such as an external hard drive, or insertable storage, such as an SD card. Storage 1324 may be persistent and/or volatile. In some embodiments, storage 1324 may take the form of a quantum computing storage device for storing data in the form of qubits. In embodiments where computer 1301 is required to have a large amount of storage (for example, where computer 1301 locally stores and manages a large database) then this storage may be provided by peripheral storage devices designed for storing very large amounts of data, such as a storage area network (SAN) that is shared by multiple, geographically distributed computers. IoT sensor set 1325 is made up of sensors that can be used in Internet of Things applications. For example, one sensor may be a thermometer and another sensor may be a motion detector.

NETWORK MODULE 1315 is the collection of computer software, hardware, and firmware that allows computer 1301 to communicate with other computers through WAN 1302. Network module 1315 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1315 are performed on the same physical hardware device. In other embodiments (for example, embodiments that utilize software-defined networking (SDN)), the control functions and the forwarding functions of network module 1315 are performed on physically separate devices, such that the control functions manage several different network hardware devices. Computer readable program instructions for performing the inventive methods can typically be downloaded to computer 1301 from an external computer or external storage device through a network adapter card or network interface included in network module 1315.

WAN 1302 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1303 is any computer system that is used and controlled by an end user (for example, a customer of an enterprise that operates computer 1301), and may take any of the forms discussed above in connection with computer 1301. EUD 1303 typically receives helpful and useful data from the operations of computer 1301. For example, in a hypothetical case where computer 1301 is designed to provide a recommendation to an end user, this recommendation would typically be communicated from network module 1315 of computer 1301 through WAN 1302 to EUD 1303. In this way, EUD 1303 can display, or otherwise present, the recommendation to an end user. In some embodiments, EUD 1303 may be a client device, such as thin client, heavy client, mainframe computer, desktop computer and so on.

REMOTE SERVER 1304 is any computer system that serves at least some data and/or functionality to computer 1301. Remote server 1304 may be controlled and used by the same entity that operates computer 1301. Remote server 1304 represents the machine(s) that collect and store helpful and useful data for use by other computers, such as computer 1301. For example, in a hypothetical case where computer 1301 is designed and programmed to provide a recommendation based on historical data, then this historical data may be provided to computer 1301 from remote database 1330 of remote server 1304.

PUBLIC CLOUD 1305 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1305 is performed by the computer hardware and/or software of cloud orchestration module 1341. The computing resources provided by public cloud 1305 are typically implemented by virtual computing environments that run on various computers making up the computers of host physical machine set 1342, which is the universe of physical computers in and/or available to public cloud 1305. The virtual computing environments (VCEs) typically take the form of virtual machines from virtual machine set 1343 and/or containers from container set 1344. It is understood that these VCEs may be stored as images and may be transferred among and between the various physical machine hosts, either as images or after instantiation of the VCE. Cloud orchestration module 1341 manages the transfer and storage of images, deploys new instantiations of VCEs and manages active instantiations of VCE deployments. Gateway 1340 is the collection of computer software, hardware, and firmware that allows public cloud 1305 to communicate through WAN 1302.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1306 is similar to public cloud 1305, except that the computing resources are only available for use by a single enterprise. While private cloud 1306 is depicted as being in communication with WAN 1302, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1305 and private cloud 1306 are both part of a larger hybrid cloud.

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the afore described computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a processor that executes computer-executable components stored in a non-transitory computer-readable memory, the computer-executable components comprising:
a modification component that inserts quantum gates or pulses in delays of one or more switch instructions in a quantum circuit to cause the delays to satisfy assumptions of zero-noise extrapolation;
an execution component that performs a plurality of executions of the quantum circuit and stretches the delays of the one or more switch instructions by a distinct stretch factor for a subset of executions; and
an analysis component that extrapolates one or more measured observables from the plurality of executions to a zero-delay limit.

2. The system of claim 1, further comprising an identification component that identifies and places the one or more switch instructions in the quantum circuit such that the one or more switch instructions are concurrent.

3. The system of claim 1, wherein the modification component inserts delays into the one or more switch instructions to cause the one or more switch instructions to consist of a same duration.

4. The system of claim 1, wherein the analysis component determines a configuration of the quantum gates or pulses to insert in delays based on measures of noise acting on qubits in a delay.

5. The system of claim 1, further comprising a correction component that error mitigates qubits that are not included in the one or more switch instructions.

6. The system of claim 1, wherein the analysis component measures noise that causes violation of the assumptions of zero-noise extrapolation during a delay.

7. The system of claim 6, wherein the analysis component determines a dynamical decoupling sequence based on the measured noise.

8. The system of claim 1, wherein the modification component employs Pauli twirling of a delay or dynamical decoupling sequences in zero-noise extrapolation.

9. A computer-implemented method, comprising:
inserting, by the system, quantum gates or pulses in delays of one or more switch instructions in the quantum circuit to cause the delays to satisfy assumptions of zero-noise extrapolation;
performing, by the system, a plurality of executions of the quantum circuit and stretching the delays of the one or more switch instructions by a distinct stretch factor for a subset of executions; and
extrapolating, by the system, one or more measured observables from the plurality of executions to a zero-delay limit.

10. The computer-implemented method of claim 9, further comprising identifying and placing one or more switch instructions in the quantum circuit such that the one or more switch instructions are concurrent.

11. The computer-implemented method of claim 9, further comprising inserting delays into the one or more switch instructions to cause the one or more switch instructions to be of same duration.

12. The computer-implemented method of claim 9, further comprising determining a configuration of the quantum gates or pulses to insert delays based on measures of noise acting on qubits in a delay.

13. The computer-implemented method of claim 9, further comprising error mitigating qubits that are not included in the one or more switch instructions.

14. The computer-implemented method of claim 9, further comprising employing Hamiltonian tomography to measure noise that causes violation of the assumptions of zero-noise extrapolation during a delay.

15. The computer-implemented method of claim 14, further comprising determining a dynamical decoupling sequence based on the measured noise.

16. The computer-implemented method of claim 9, further comprising employs Pauli twirling of a delay or dynamical decoupling sequences in zero-noise extrapolation.

17. A computer program product comprising a non-transitory computer-readable memory having program instructions embodied therewith, the program instructions executable by a processor to cause the processor to:
insert quantum gates or pulses in delays of one or more switch instructions in the quantum circuit to cause the delays to satisfy assumptions of zero-noise extrapolation;
perform a plurality of executions of the quantum circuit and stretch the delays of the one or more switch instructions by a distinct stretch factor for a subset of executions; and
extrapolate one or more measured observables from the plurality of executions to a zero-delay limit.

18. The computer program product of claim 17, wherein the program instructions are further executable to cause the processor to:
identify and place one or more switch instructions in the quantum circuit such that the one or more switch instructions are concurrent.

19. The computer program product of claim 17, wherein the program instructions are further executable to cause the processor to:
insert delays into the one or more switch instructions to cause the one or more switch instructions to be of same duration.

20. The computer program product of claim 17, wherein the program instructions are further executable to cause the processor to:
employ Pauli twirling of a delay or dynamical decoupling sequences in zero-noise extrapolation.
